(19) United States
(12) Patent Application Publication
(10) Pub. No.: US 2011/0267201 A1
(43) Pub. Date: Nov. 3, 2011

(54) Dual Purpose Toilet Seat Light

(76) Inventor: Don Bucha, Montgomery, TX (US)

(21) Appl. No.: 12/771,448

(22) Filed: Apr. 30, 2010

(51) Int. Cl. G08B 21/00; F21V 9/00

(52) U.S. Cl. 340/686.1; 362/231

(57) ABSTRACT

A device to provide night time illumination in the area of a toilet, providing a motion detector to indicate when illumination should be turned on, and providing two light sources, one to provide general illumination around the toilet when the seat is in its lowered position, and the other to provide illumination of the toilet bowl area when the seat is in its raised position.

### FIELD OF THE INVENTION

The invention pertains to lights used to illuminate toilet seats to allow nighttime use of a toilet without turning on brighter room illumination.

### BACKGROUND OF THE INVENTION

Many attempts have been made to provide night-time illumination of a toilet so that it can be used without turning on bright room lights. However, these attempts have failed to produce an illumination device that satisfies the needs of both male and female users.

For example, U.S. Pat. No. 5,664,867 to Martin, et al. discloses a toilet seat light operated by a tilt switch, such as a mercury switch, so that the light turns on when the seat is lifted, and turns off when the seat is lowered. This configuration has the advantage of illuminating the bowl area of the toilet for male users, but only after one has located the toilet and lifted the seat. This device provides no advantages for female users at all.

Similarly, U.S. Pat. No. 5,611,089 to Cretors discloses a toilet light comprising a series of LED lights on the underside of the seat. The device contemplated by this disclosure requires that it be manually switched on and off, an approach that again works only once one has located the toilet, and in this case, the switch.

U.S. Pat. No. 5,437,066 to Mills, et al. and U.S. Pat. No. 5,513,397 to Terry disclose devices similar to that of Martin, et al., in that the light is activated when the toilet seat is moved to a raised position. Again, this approach requires one to find the toilet and raise the seat, and offers no advantage to female users.

U.S. Pat. No. 5,748,096 to Kaufer proposes the use of another toilet light that is activated by lifting the seat, which retains the disadvantages discussed above. Additionally, Kaufer includes an annunciator that can provide a recorded aural reminder to lower the seat. This configuration has the additional disadvantage that the annunciator may disturb other people sleeping withing earshot.

U.S. Pat. No. 3,982,288 to Borne discloses a toilet light that serves as a night light, but turns off when the toilet seat is raised. While presumably of advantage to female users, the disclosure of Borne provides no apparent aid to male users, who would still need to turn on the room lights.

It is desirable to provide a toilet seat light system that provides sufficient illumination at night without the need to detrimentally affect night vision by turning on the primary room lights. It is further desirable to provide a toilet seat light system that conserves power by only turning on when movement is detected in the vicinity of the toilet, and that provides an indication to the user of whether the toilet seat is in the raised or lowered position.

### SUMMARY OF THE INVENTION

The invention is a device for providing illumination in the area of a toilet, comprising a position detector that provides a position signal indicating whether the toilet seat is in its raised or its lowered position, a motion detector for detecting motion in the proximity of the toilet, a first lamp that is positioned to illuminate the toilet bowl area when the toilet seat is in its raised position, a second lamp that is positioned provide general illumination when the toilet seat is in its lowered position, and a lamp control that activates either the first lamp or the second lamp when the motion detector indicates that there is movement within a predetermined distance of the toilet, based upon the position of the toilet seat.

For example, if movement is detected within the predetermined distance from the toilet, and the position detector indicates that the toilet seat is in its lowered position, the lamp control will illuminate the second lamp, providing a general illumination around the area of the toilet that is sufficiently bright to see by at night, but is preferably not so bright as to adversely affect the night vision of a person moving in that vicinity. This general illumination has two advantages, because it both provides the user with sufficient illumination to see, and provides a positive indication of the toilet seat position.

Conversely, in nearly the same circumstance of the previous example but when the toilet seat is in its raised position, the lamp control will illuminate the first lamp, providing an illumination of the toilet bowl. Again, regardless of whether the user is male or female, the first lamp will provide sufficient light to see by (and again, preferably not so bright as to adversely affect night vision), and again provides a positive indication of the position of the toilet seat.

Both the first lamp and the second lamp are preferably LED devices, for power conservation purposes. However, those of skill in the art will recognize that “lamp” may encompass incandescent, fluorescent, or any other manner of lighting device, without departing from the spirit of the invention, and that, similarly, either the first lamp or the second lamp may comprise one or more illumination devices, positioned in a way that is a matter of engineering choice.

In accordance with the invention, the user is automatically provided not only with sufficient (but not overbearing) lighting, but is also provided with a positive indication of whether the toilet seat is raised or lowered, and will thus know whether the toilet seat is in its desired position, or whether it should be moved. In a preferred embodiment of the invention, the first lamp and the second lamp have different colors, to provide a further reinforcement, in addition to the illumination provided, to indicate the position of the toilet seat. Preferably the color of the first lamp and of the second lamp will be preselected to reduce degradation of night vision. Additionally, those of skill in the art will recognize that, preferably, the lamp control will automatically shift illumination from the first lamp to the second lamp, or vice versa, if the toilet seat is lowered or raised, after either lamp has been turned on.

Additionally, a timer may be added to the lamp control to automatically turn off either the first or second lamp (depending on which is, at the time, turned on) following a preselected time after the signal from the motion detector goes “inactive.” (That is, after motion is no longer detected in the vicinity of the toilet). Should some condition require the user to remain near the toilet beyond this time, any motion within range of the motion detector will suffice to turn the system back on, and re-set the timer.

In another embodiment, a photocell, or similar device, can be utilized to prevent the lamp control from illuminating either lamp if the ambient light level is above a predetermined level, thus saving power when the user has sufficient light from other sources.

### BRIEF DESCRIPTION OF THE DRAWINGS

FIG. 1 is a schematic view of a device of the present invention, with lamps attached to the underside of a toilet seat (shown in the raised position).

### DETAILED DESCRIPTION

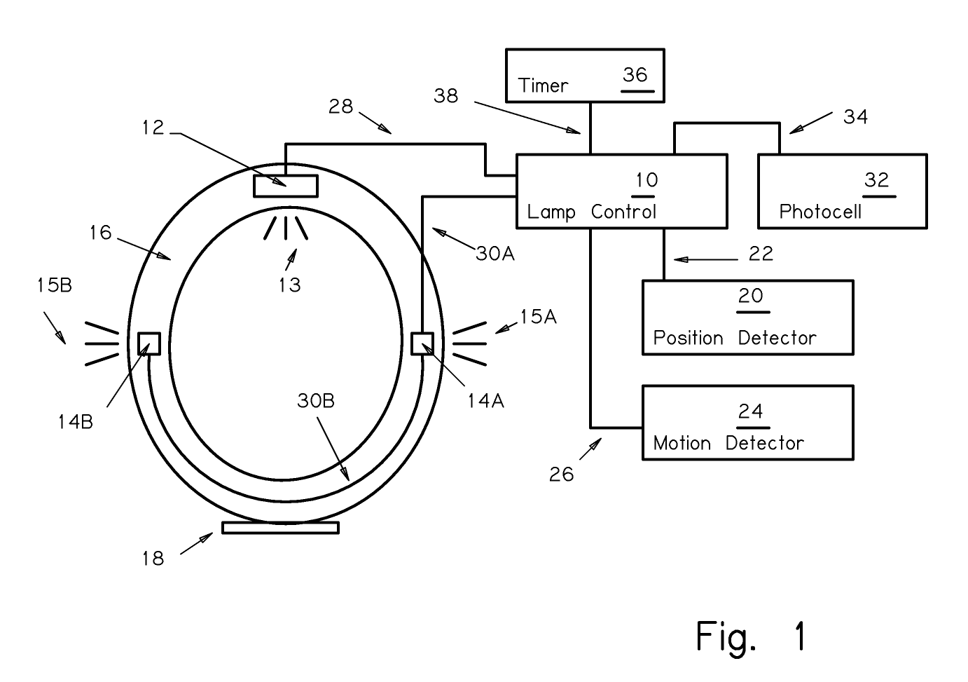

Referring to FIG. 1, a schematic view of an embodiment of the present invention is shown. Lamp control 10 is in signal communication with first lamp 12, and second lamp 14A, 14B. It will be understood by those of skill in the art that first lamp 12 may comprise more than one lighting component, and second lamp 14A, 14B may comprise only one component, or more than the two example components shown. The examples given in FIG. 1 are intended by way of example, only, and do not limit the scope of the invention. Additionally, it will be understood that, although first lamp 12 and second lamp 14A, 14B are schematically shown in FIG. 1 to be mounted on the underside of toilet seat 16, their positioning is a matter of engineering choice only, and they may be mounted anywhere that their function may be reasonably accomplished.

Both first lamp 12 and second lamp 14A, 14B preferably are LED lamps, but may be any combination of LED, incandescent, fluorescent, or any other type of controllable light-emitting device. First lamp 12 and second lamp 14A, 14B also preferably provide different color illumination, thus providing an additional signal to the user of whether toilet seat 16 is in a raised position or a lowered position.

Toilet seat 16 (shown in a raised position) is joined by hinge 18 to a toilet (not shown), and it will be understood by those familiar with the art that toilet seat 16 may be pivoted about hinge 18 from a raised position to a lowered position, and vice versa. Hinge 18 may, of course, comprise one or more hinged couplings.

Position detector 20 is in signal communication with lamp control 10 via first signal line 22. Position detector 20 senses the position of toilet seat 16, and may comprise any manner of sensor, including, without limitation, a contact switch, a gravity switch, an optical switch, or any other device used for detecting the rotational position of an object.

Motion detector 24 is in signal communication with lamp control 10 via second signal line 26. When motion detector 24 is “active,” indicating that there is movement in a predetermined proximity of toilet seat 16, lamp control 10 switches on either first lamp 12 or second lamp 14A, 14B, based on information provided by position detector 20. If position detector 20 indicates that toilet seat 16 is in a raised position, lamp control 10 will turn on first lamp 12 via third signal line 28. Conversely, if position detector 20 indicates that toilet seat 16 is in a lowered position, lamp control 10 will turn on second lamp 14A, 14B via fourth signal line 30A, 30B.

First lamp 12 is preferably mounted and oriented so that its illumination is directed toward the toilet bowl (not shown), as indicated by ray lines 13. By contrast, second lamp 14A, 14B is preferably mounted and oriented so that its illumination is directed outward around the periphery of the toilet, as indicated by ray lines 15A, 15B. In this way, first lamp 12 provides illumination of the bowl for a standing user while toilet seat 16 is raised, and second lamp 14A, 14B provides general illumination of the toilet area for a sitting user while toilet seat 16 is lowered. The nature, and preferably the color, of the illumination will also provide a ready indication to an approaching user of whether toilet seat 16 is raised or lowered, and thus whether it needs to be moved.

The device may also comprise a photocell 32 in signal communication with lamp control 10 via third signal line 34, allowing lamp control 10 to not illuminate any of first or second lamps 10, 14A, 14B if the ambient light level is above a preselected value, thus saving power. Additionally, the device may also comprise a timer 36 in signal communication with lamp control 10 via fourth signal line 38, to signal lamp control 10 to turn off all lamps a preselected time after they were turned on. If the user is still in the vicinity when the lamps go off, the user can quickly turn them back on by moving, which will activate motion detector 24, again.

Those of skill in the art will recognize that the above described components may be mounted together or separately, or integrated into a combined device, without departing from the spirit of the invention. Accordingly, the above description is provided by way of example only, and does not limit the scope of the claimed invention.

I claim:

1. A device for selectively illuminating an area in proximity to a toilet comprising a bowl and a seat rotatably attached to the toilet, the device comprising
a position detector providing a position signal indicating whether the seat is in a raised position or a lowered position,
a motion detector providing a motion signal when motion is detected within a predetermined distance from the toilet,
a lamp control in signal communication with said position detector and said motion detector, wherein said lamp control turns on a first lamp when said motion signal becomes active and said position signal indicates that the seat is in a raised position, and turns on a second lamp when said motion signal becomes active and said position signal indicates that the seat is in a lowered position.

2. The device of claim 1, wherein said first lamp and said second lamp provide illumination in different colors.

3. The device of claim 1, wherein said first lamp provides illumination directed towards the bowl of the toilet.

4. The device of claim 1, wherein said second lamp provides illumination about the circumference of the toilet.

5. The device of claim 1, additionally comprising a timer in signal communication with said light control, and wherein said light control turns off power to said first lamp and said second lamp a predetermined time after said motion signal becomes inactive.

6. The device of claim 1, wherein said first lamp provides illumination at an intensity preselected to aid in preserving night vision.

7. The device of claim 1, wherein said second lamp provides illumination at an intensity preselected to aid in preserving night vision.

8. The device of claim 1, wherein said first lamp provides illumination in a color preselected to aid in preserving night vision.

9. The device of claim 1, wherein said second lamp provides illumination in a color preselected to aid in preserving night vision.

10. The device of claim 1, additionally comprising a photocell in signal communication with said light control, wherein said light control will turn off power to both said first lamp and said second lamp when ambient illumination is above a preselected level.

11. The device of claim 1, additionally comprising a timer in signal communication with said lamp control, and wherein said lamp control turns off illumination after a predetermined time after said motion signal becomes active.
